(19) United States
(12) Patent Application Publication
(10) Pub. No.: US 2005/0015281 A1
(43) Pub. Date: Jan. 20, 2005

(54) System for achieving and maintaining long term wellness

(76) Inventors: Chris C. Clark, Plymouth, MN (US); Janal M. Kalis, Minneapolis, MN (US)

Correspondence Address: Schwegman, Lundberg, Woessner & Kluth, P.A., P.O. Box 2938, Minneapolis, MN, 55402, US

(21) Appl. No.: 10/940,478

(22) Filed: Sep. 14, 2004

(51) Int. Cl. G06F 17/60; G06F 17/00

(52) U.S. Cl. 705/2; 235/375

(57) ABSTRACT

A system for optimizing performance and for maintaining wellness of an athlete, comprising: a smart card for receiving, storing, and transmitting data regarding one or more of heart rate, weight, age, and gender of an athlete and instructions from the athlete's trainer or the athlete's health club or both regarding exercise; a processor for processing data obtained from the smart card; a database with electronic fitness records for the a plurality of athletes, the database comprising data obtained from the smart card; and, access enabling the athlete's trainer, the athlete's health club or both to access the fitness records of all of the athletes that the trainer trains.

The application describes inventive subject matter that relates to embodiments of a system and to embodiments of a method that enables an athlete to achieve and maintain optimal performance and long term wellness with the assistance of a trainer.

### BACKGROUND OF THE INVENTION

There are many factors in the world today that challenge the wellness of individuals. One important factor is obesity. Obesity is increasing world-wide and is set to become the world's biggest health problem. Recent reports suggest that it may soon overtake cigarette smoking as a serious health risk. In the UK, nearly two-thirds of men and over half of all women are now overweight—and 1 in 5 are obese. The level of obesity has tripled in the past 20 years, and is still rising. At this rate, by 2010 at least 1 in 4 adults will be obese. Overweight and obesity is rising among children too.

These statistics are alarming because overweight, and especially obesity, increase the risk of many health problems: Type 2 diabetes, heart disease, certain cancers, stroke, back and joint pain, osteoarthritis, infertility, breathlessness, depression, snoring and difficulty sleeping—to mention a few. Being obese is not only a cosmetic issue, it is a serious health issue. Quite simply, obesity can stop individuals from getting the best from life. In fact, a high profile report from the National Audit Office in UK, concluded that obesity could shave an average of 9 years from the life span of individuals.

Americans, young and old, have also become obese at an alarming rate. A study of Minnesotans, for instance, found that a third of the state's population was obese. The cause of obesity, in most instances, was that people consumed more calories than they burned. People tend to consume pre-prepared meals that they purchase at a restaurant or grocery store. Portion sizes of these pre-prepared meals found in grocery stores or restaurants contribute to the problem of obesity because portion sizes have been getting larger with time. The problem is made worse because a high percentage of calories in these prepared meals are due to the fat and sugar content of the foods.

Inadequate exercise compounds the problem of excessive calorie consumption. A majority of Americans do little or no exercise. A quarter of the population of Minnesota in the group studied did not exercise at all. Thus, the calories required for weight maintenance are marginal. Furthermore, individuals who do not exercise lack muscle mass. Muscles consume calories at rest. Fat does not.

Although it is easy to articulate the caloric imbalance aspect of the problem, it has not been possible to reverse the trend that people who have become overweight or obese have, for the most part, been unsuccessful in removing the weight and keeping it off. It has not been enough for people to consume fewer calories for a limited period of time. Many people who go on diets don't lose weight. More individuals losing weight cannot maintain the new lower weight.

Information regarding weight loss and exercise has been geared to obtaining short term results. Weight loss services provide information on how to lose a quantity of weight, such as ten pounds. Trainers provide information on how to get ready for a specific event. Automated training regimens are geared for averages, not real people over a long period of time. On-going information, expressly provided for a particular individual for many years—over the individual's life—is not available. As a consequence, individuals do not know how to achieve and maintain goals of optimal weight and wellness without resorting to extreme surgical procedures to cut the fat out of their bodies or to cut all or a portion of the individuals' digestive systems out of their bodies.

Individuals see only bits and pieces of a wellness puzzle and are unable to adjust to changes in their physical and mental health due to aging, stress, injury, depression, job changes, pregnancy, burn-out and other challenges in daily life. The behavior that worked for them in the past fails them in the present and future.

### BRIEF DESCRIPTION OF THE FIGURES

FIG. 1 is a schematic view of one embodiment of the system of the invention described herein.

FIG. 2A is a top, front plan view of a smart card used in the system of the invention described herein.

FIG. 2B is a top rear plan view of the smart card of FIG. 2A.

FIG. 3 is a schematic view illustrating data storage on the smart card of FIGS. 2A and 2B and data transfer to a database.

FIG. 4 is a schematic view illustrating authentication and data transfer using the smart card of FIGS. 2A and 2B.

FIG. 5 is a schematic view of one other embodiment of the system of the invention described herein.

### DETAILED DESCRIPTION

The description uses terms that are defined as described herein:

### Definitions

The term “athlete” as used herein refers to any individual that is engages in any type of physical exercise.

The term “health club” as used herein refers to any organization of individuals that include at least one athlete and at least one trainer.

The terms, “trainer” and “trainers” as used herein refer to a person or people trained in monitoring heart rate to measure activity levels for each person that they train. Trainers assist the people that they train by creating training programs that allow them to achieve and maintain an objective with respect to weight or energy level or endurance or fitness or all of these goals. Trainers monitor progress for each person that they train and report progress to each person. In some embodiments, trainers create programs for each individual that they train based upon heart rate and fitness. In some embodiments, trainers train with the people they are training.

The term, “master trainer” as used herein, refers to a trainer who trains other trainers.

The term, “Aerobic heart rate” refers to 70 to 80 percent of the maximum anaerobic heart rate.

The term, “Anaerobic heart rate” refers to 80 to 90 percent of the maximum anaerobic heart rate.

The term, “Wake-Up heart rate” refers to the heart rate of an individual when he or she wakes up.

The term, “Maximum aerobic heart rate” refers to the maximum heart rate achievable before significant lactic acid production The term, “Maximum anaerobic heart rate” refers to the maximum heart rate that an individual can reach. The maximum anaerobic heart rate can be reduced by a lack of conditioning but cannot be exceeded.

### Disclosure

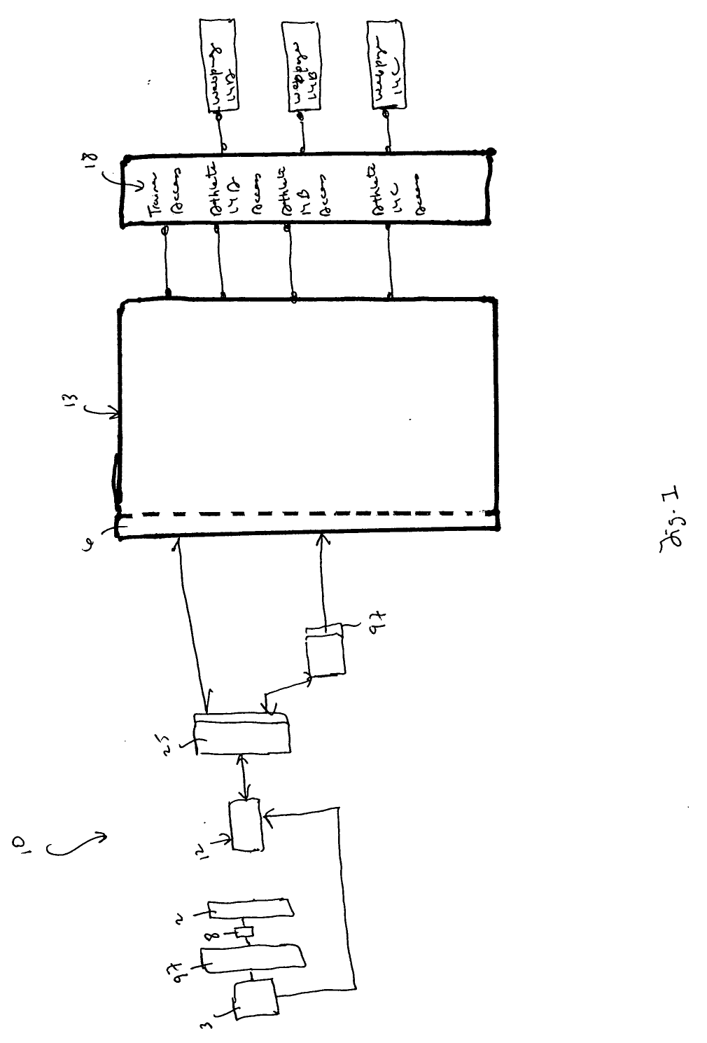

A system of the invention, for optimizing performance and for maintaining wellness of an athlete, illustrated for one embodiment at 10 in FIG. 1, includes a smart card 12 possessed by the athlete, that includes information such as the athlete's identification information; a database 13 with electronic fitness records for the a plurality of athletes; access portals 16a 16b and 16c enabling the athlete 14A, 14B and 14C to access his or her electronic records; and a trainer access portal 18 enabling the athletes' trainer to access the fitness records of all of the athletes that the trainer trains. The system also includes a portal 21 that enables the trainer to enter and to store plans for each athlete that he or she trains.

For one embodiment, the athlete accesses the trainer's plan through a webpage accessible by the athlete and the trainer. The trainer may post exercises for the athlete to perform and make other comments regarding nutrition and the state of fitness of the athlete. The athlete may post comments on this page for the trainer. The athlete may use e-mail accessible through the page to contact the trainer. In one embodiment, the trainer sends an e-mail to the athlete with information regarding training. In another embodiment, the system automatically sends e-mail reminders or e-mail reports to either the trainer or the athlete or both. As used herein, a trainer may be an individual person as defined above for some embodiments, a health club for other embodiments, a nutritionist for other embodiments, and a weight loss organization or company for other embodiments.

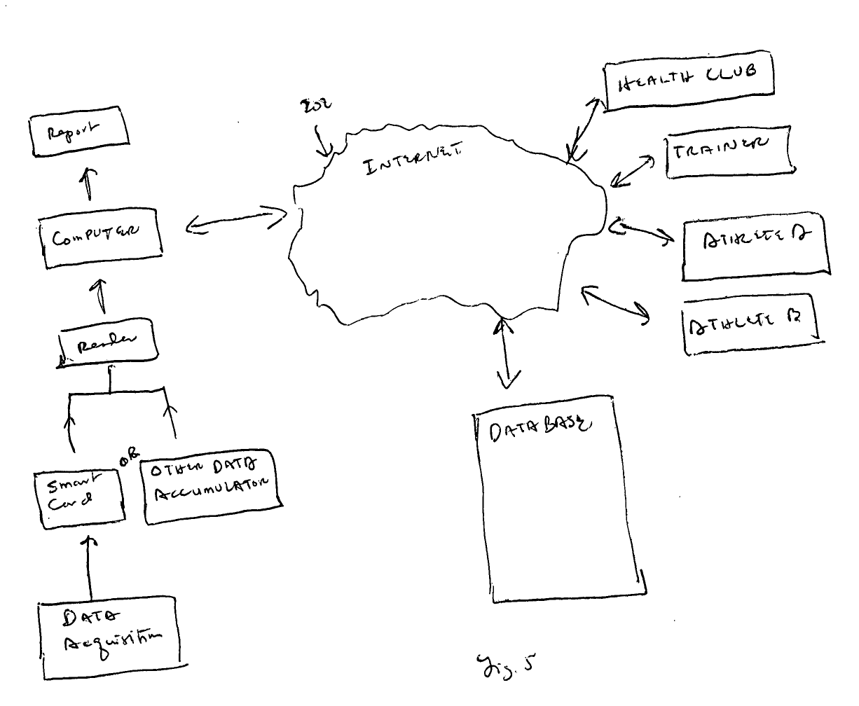

In another embodiment illustrated at 200 in FIG. 5, the database 13 is accessible though the Internet 202 by the athletes 14A, 14B, and 14C, trainers, and designated health club personnel.

The smart card 12 accumulates data regarding exercise in the form of heart rate data and duration of the exercise, and, for some embodiments, weight and uploads it to the database 13 via a computer or other device with Internet access and the Internet. The system of the invention is web-enabled for some embodiments and for other embodiments, is a local network. With the web enabled embodiment, athletes and trainers access web pages through a URL. With the local network, trainers and athletes access data through an intranet.

Some embodiments of the system of the invention also include fitness equipment 22, such as equipment for cardiovascular training and equipment for weight training, each with a card reader 25 capable of reading the trainer's plan from the smart card 12 for each athlete and capable of transmitting updated electronic fitness records such as heart rate information, calories burned, lactic acid concentrations, and duration of the exercise for storage to the database 13 accessible by the trainer. For some embodiments, at least a portion of the electronic fitness records are stored within a memory on the smart card.

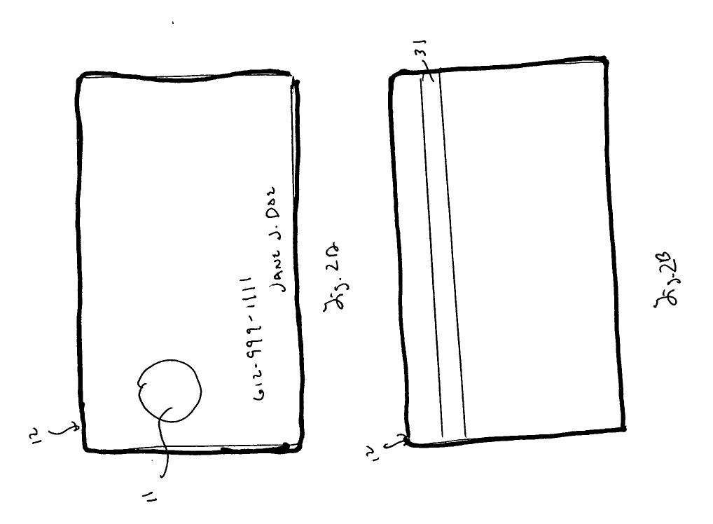

One embodiment of the smart card is illustrated at 12 in FIGS. 2A and 2B. Features of the card 12 include a first identifier such as a smart chip 11 which includes a microprocessor for receiving data from the database, for sending data from wireless devices to the database, and for storing data. For some embodiments, the smart chip 11 serves as an authentication mechanism for connection to a health club or other fitness-based group and to the database 13 which stores electronic fitness records The smart card also includes, for some embodiments, a second identifier such as a magnetic strip 31 which serves as an authentication means for connection to a payment network and for checking into the health club. Some smart card embodiments also include a number 33 or URL to retrieve a web-page from the health club or other fitness group through a web browser. For some embodiments, the smart card 12 also includes a number or URL for retrieving the web page of the athlete holding the card. For some embodiments, the card also includes contact information for contacting the athlete's trainer.

In one embodiment, the storage of the first identifier is partitioned into 4 sectors, which respectively store: (a) general data of the athlete including emergency contact data, weight, height, age, and so forth (b) trainer's plan for the athlete, which is updated as the trainer determines is necessary; (c) Real time data gathered from exercise machines at or associated with the health club or other fitness group; and (d) Encrypted password for identity authentication.

Data obtained and stored in (a)-(c) are referred to herein as “Electronic Fitness Records.” The electronic fitness records are transmitted to the electronic database 13, which is located, for some embodiments, on a server under direct or indirect control of the health club or other fitness organization having the athlete as a member.

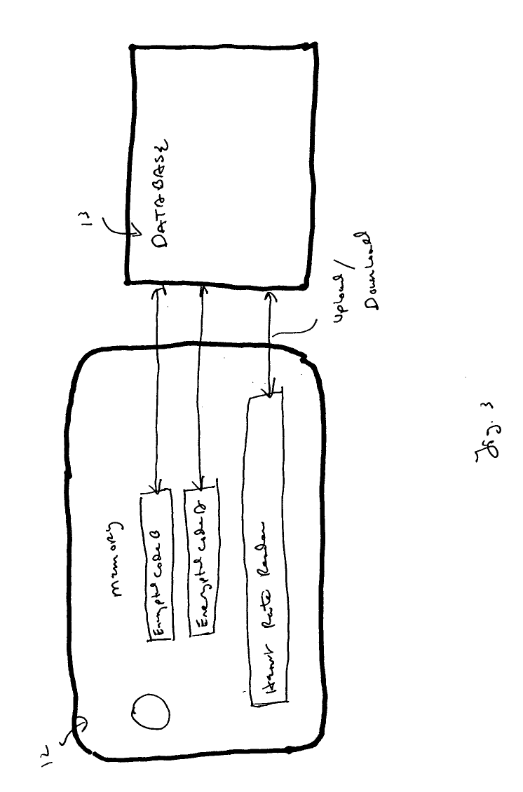

A schematic diagram of communication flow between a card and a network/or exchange is illustrated in FIG. 3.

The first identifier of the smart card 12 includes a READ and WRITE memory and/or microprocessor. For some embodiments, the first identifier is a Java chip. The first Identifier has as its minimal function, identity authentication. The first identifier also includes a memory for the further function of recording a transaction in accordance to date, time and the assigned code number of the reader. The first identifier has further memory functions of storing data, wherein the data is not limited to user's particular statistics and electronic fitness record. The data in the entire memory of the first identifier is referred to as “encrypted code A”.

The second Identifier, is for some embodiments, one or more of a barcode, magnetic strip, smart chip or a JAVA smart chip. The identifier has a memory for data relating to credit card information of the smart card holder and is referred to as “encrypted code B”.

In other smart card embodiments, the smart card includes radio frequency identification (RFID) and includes components that enable the card to transmit and receive data to and from other RFID devices. Long distance has a benefit of transmitting data without a need for card swiping. While a smart card is described herein as having a microprocessor and RFID technology, other smart card embodiments include RFID technology or microprocessor technology. It is believed that any programmable smart card is usable in the system of the invention described herein.

The smart card has an emergency number printed on the card. For one embodiment, during an emergency situation, this number can be used as the login number to access a summary page of predefined information relating to the cardholder, such as critical health data, allergy, next of-kin's particulars, and so forth through a web browser. In the present context, the summary page is named, “emergency page” or “e-page”. For other embodiments, the emergency number is used to reach the athlete's physician directly.

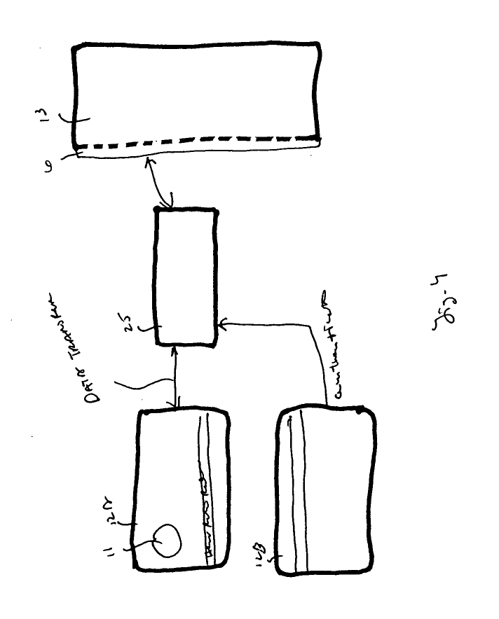

Referring to FIG. 4, at the point of initiation, the athlete submits his or her smart card 12 to the health club for authentication and update of data. For illustration purpose, assume the service to be purchased by the athlete is a session with the user's trainer. A contact or contactless communication is then initiated between the identifier and its dedicated reader, followed by, for some embodiments, providing a password on a 20 keypad or fingerprint on a big-metric reader.

Encrypted code B is stored in the memory of second identifier while encrypted code A and other identifier data are stored in the memory of first identifier.

When a health club identifier is inserted/or swapped or passed near its reader, 25 encrypted code A is sent from the memory of the smart card 12 to the database 13 of health club (21) for an authentication process. Thereafter, if the authentication is successful, both electronic fitness records stored in the card and in the database of health club are compared with respect to their dates of modification. Only the oldest in the first Identifier of the smart card is updated while the latest record is uploaded and archived in the database of the health club database. This is to keep all histories relating to a smart card holder as an audit trail in the database of the health club. While this authentication is presented as an embodiment of the invention, it is understood that other conventional authentication methods are suitable for use in the invention. Once authentication is completed, data in encrypted code A and encrypted code B are uploaded to the database 13. Any instructions from the trainer are downloaded to the card 12.

While encrypted code A and encrypted code B are described herein, it is understood that other data storage configurations of encrypted and unencrypted data are suitable for use on the smart card used in the system of the invention described herein.

Fitness equipment 22 usable in the system of the invention includes equipment for cardiovascular training and equipment for weight training. Each piece of fitness equipment includes a card reader 25 for reading the trainer instructions from the smart card. For some embodiments, some or all equipment at a health club are on a common network. For this embodiment, the athlete need only swipe his or her card once to activate trainer instructions for all pieces of equipment. For other embodiments, the athlete swipes his or her card with each change of equipment. Some fitness equipment embodiments also include a transmitter for transmitting heart rate information from an athlete wearing a heart rate monitor to the database 13. For other embodiments, the athlete transmits heart rate data and other data related to an exercise to the database using an infrared transmitter and receiver.

For cardiovascular training equipment, the smart card 12 imparts trainer instructions that direct the piece of equipment to initiate a specific cardiovascular program created for the athlete by the trainer. The equipment initiates the instructions automatically once the smart card is inserted into a card reader associated with the machine. For weight training, the smart card imparts trainer instructions to the athlete regarding weight and reps and the athlete activates the machine. For some embodiments, the weight equipment includes a display or print out that displays the trainer instructions for the athlete when his or her smart card is inserted into a card reader associated with the equipment. For other embodiments, the athlete obtains the printout when checking into the health club.

Types of smart cards usable in the system of the invention include but are not limited to an RS 232 card; a USB card; a Windows CE standard compatible card or even an ADVANTECH 5820/I card. Transmission protocols will be different in each case and may be identified for instance in the UMTS protocol for the transmission of video programs; in the WAP protocol usable for wireless communication, for instance with infrared beams, between computer and physical devices associated thereto. Said protocols may be employed, by way of non limiting indication, to allow the exchange of information for instance between communication terminal and information system or, or also, between input means, output means, processing unit and terminal. The Basic Card from Zeitcontrol (www.zeitcontrol.com/) can be programmed in Basic. Zeitcontrol has done a excellent job of integrating the development of the program on the smart card with the development of the program on the host or terminal that is using it. The MULTOS (www.multos.com/) smart card is a smart card defined by MAOSCO, a spin-off of MONDEX and MasterCard. The MULTOS card can be programmed in C and in MEL (MAOS Executable Language), which is the assembly language for the virtual machine on the card. Keycorp (www.keycorp.com.au) is marketing a smart card called OSSCA (Operating System for Smart Card Applications) which you can program in the Forth language. A number of card manufacturers have announced cards which can be programmed in Java but only Schlumberger (www.cyberflex.austin.et.slb.com) has production cards on the market. Gemplus (www.gemplus.com) is making available 32-bit experimental cards that run Java. Both Syprus (www.syprus.com) and Datakey (www.datakey.com) have cards in development that let you add programs written in native assembler. The operating system on the Syprus card is called SPYCOS and the operating system on the Data key card is called DKCCOS. The HOST operating system from Oberthur (www.oberthurkirk.com) is also advertised as supporting the field loading of native code applications.

While specific cards are described, it is understood that other smart cards are usable in the invention embodiments described herein. As discussed, in another embodiment the smart card employs radio frequency identification (RFID).

The system 10 further includes at least one sensor 97 provided to measure one or more parameters relating to the physiological state of the user 2 and communicate them to the database 13 through a processing system 6.

Suitable sensors 97 include a heart rate monitor 7 applied to the body of the athlete 2. For some embodiments, during the execution of a work program, the heart rate monitor allows an information system 3 to verify and keep under control the physiological parameters of the user 2, monitoring them during the activity. Another embodiment of the sensor mechanism 97, measures a mechanical state of the athlete 2, such as his or her instantaneous position. This type of optional sensor relies upon the use of a satellite position indicator 8. Knowledge of the instantaneous position of the athlete 2 allows the information system 3 to perform computations to determine the distances covered by the athlete during his/her daily ambulation or work activity, or during the execution of other activities such a walk or a run. These computations estimate the time and speeds of workouts, energy expenditure of the athlete. These parameters are useful to the trainer in determining a realistic requirement for exercise activity for the athlete, and consequently, enabling the preparation of activity programs specifically tailored for the athlete. Data obtained from the sensor is communicated to the memory storage area on the smart card 12 using a conventional wireless mechanisms and is, for some embodiments, stored on the smart card. When the user 2 has his or her card read by the health club card reader, 25, the data on the card 12 is processed at 6 and uploaded to the database 13. For other embodiments, the sensor device is read directly by a reader at the health club, such as an IR or RFID reader.

The data on the smart card is accessible by the athlete's trainer over the World Wide Web, as shown in FIG. 2. For one embodiment, the trainer has his or her own password for accessing the electronic fitness records of the athlete he or she trains. The trainer reviews the records and makes changes in the athlete' training plans, as needed. When the athlete returns to the health club and has his or her card swiped, the trainer instructions are updated and transported with the athlete's card.

In operation, the athlete checks in with a health club and has his or her smart card read in a card reader 25. If the trainer has provided workout recommendations, these recommendations are shown on a display and may be printed and given to the athlete. For some embodiments, the athlete obtains trainer instructions from his or her page on the World Wide Web. If the athlete works out on an aerobic machine, he or she submits the smart card into a card reader associated with the machine.

The machine reads any workout programs specified by the trainer. When the machine is activated, the program is run. For some embodiments, heart rate of the athlete is read by a receiver on the machine and the heart rate data for the athlete is transmitted to the database 13.

Other types of workouts that the athlete's trainer may recommend include workouts off a machine, such as running outside. For these workouts, the athlete wears a device such as a heart rate monitor. The heart rate monitor may calculate and store additional exercise data. Additional data includes but is not limited to calories burned, ambient temperature, and time of the workout. For some embodiments, the heart rate data is transmitted from the heart rate monitor to the smart card. When the smart card is read by a card reader associated with the health club, the heart rate data is uploaded to the database 13. For other embodiments, the heart rate data is uploaded to the database 13 by the athlete, using the athlete's webpage. While heart rate is described herein, it is understood that other types of workout data may be measured and uploaded to the database.

For some embodiments, the trainer is notified of new activity in the database of the athletes he or she trains by e-mail or by checking a notification screen or both. The trainer has access to the database of each athlete and may review data or plan a workout regimen or both for the athlete. The trainer may also schedule one-on-one time with the athlete. With the system and method of the invention, a trainer in great demand is able to improve his or her effectiveness with each athlete trained and may be able to train many more athletes than is possible without use of the invention embodiments described herein. Further, the athlete has the benefit of interacting with a human trainer whose knowledge base is amplified by the information in each athlete's database.

In some embodiments, the trainer assists the individual in stress management using group exercise activities, teaching meditation techniques with exercise, and in exercises such as yoga and boxing. Each of these exercises includes at least one metric, such as weight, that is measured and uploaded to the database 13 for storage and for ongoing evaluation by the trainer. The trainer works with the individual one-on-one for some embodiments, and in a group for other embodiments.

The invention also includes one system embodiment for achieving and maintaining wellness for individuals throughout their lifetimes. The system includes a master trainer selecting a group of people to be trainers and providing to each person in the group, information on heart rate training, diet management and stress management. The information is provided in training meetings and in on-going follow-up meetings. For some embodiments, a portion of the training is performed using the World Wide Web. Each person selected to be a trainer is also provided with a heart rate monitor and an exercise log. For some embodiments, each person is also provided with a food log. Part of the training includes the person using heart rate monitor training in his or her own life.

For some embodiments, the trainers and athletes have smart cards, as have been described herein, and access the database. The Master Trainer has access to all athlete and trainer records. Other trainers have access to the records of the athletes they train. Trainers and athletes may grant viewing privileges of selected records to each other.

Once the selected individuals have received sufficient training to be trainers, they identify and select one or more individuals that they would like to train. The individuals typically are friends, neighbors, and co-workers. They invite the individuals to a gathering to discuss heart rate training principles. At the gathering, the trainers make themselves available as trainers to the individuals. They provide packages containing heart rate monitors, training logs, and optionally diet logs to interested individuals for a fee. The trainer makes appointments with all individuals who desire training. The trainer notifies the master trainer of the individuals desiring training. The master trainer and trainer work together to prepare a heart rate training plan for each individual that they train. The trainer and master trainer understand that each training program is different and is based upon the age, physical condition, weight, and conditioning of each individual. As discussed above, the training program is based upon heart rate for given states of health and conditioning.

The trainer and master trainer identify specific metrics for the individual to monitor and check on a regular basis. The metrics include weight, resting heart rate, waking heart rate, resting calorie burn, aerobic heart rate range, anaerobic heart rate range, and maximum anaerobic heart rate.

In order to make it easier for the individual to follow the program created by the trainer and the master trainer, the trainer selects people that he or she knows and sees often. The trainer is able to apply peer pressure to encourage the individual to continue with the program. If an individual that the trainer trains has to make a geographic move, the trainer recommends trainers in the individual's new city. For some embodiments, the trainer recommends a master trainer in the new city that the individual may contact.

For some embodiments, the trainer charges each individual that he or she trains a fee. The fee is split with the master trainer to cover the time that the master trainer spends training and advising the trainer for that individual. For some embodiments, a portion of the fee is added to a fund for funding special projects or events or for providing bonuses to exemplary trainers and master trainers. The trainers and master trainers are independent contractors and are not employees.

In one embodiment, the trainer provides group training as well as one-on-one training. The group training includes group walks and runs. In one embodiment, the master trainer plans larger events for multiple trainers and the individuals they train. The events include races, triathalons, and adventure races.

Trainers are discouraged by master trainers from taking on more individuals for training than they can properly manage. Trainers are encouraged by the master trainers to provide the best training possible for each individual that they train. Trainers are recommended to be master trainers by the master trainer who trained them. Once recommended, the trainer must be found to meet pre-selected criteria. Master trainers train other trainers and individuals.

For some embodiments, master trainers select an events coordinator to set-up group events for a city or region. The events coordinators are master trainers.

In one embodiment, race data for an athlete is entered into the database 13. The race data is entered manually in some embodiments and electronically, for other embodiments. In one embodiment, the smart card serves the same function as chips play in races such as marathons, by recording date, time the athlete runs across the starting line and finish line, split information, and total race time, miles per hour, and so forth. The race data is uploaded into the database 13 when the card 12 is swiped at the health club.

The race data is accessible by the athlete and his or her coach. In one embodiment, the race data is presented on a web page accessible by the athlete and the trainer. For other embodiments, the athlete's race page is viewable by others designated by the athlete. In one embodiment, groups of athlete's have their race performances cumulatively compared. Winners and losers are determined. Incentives are provided to athletes having the highest cumulative racing scores. This allows athletes of similar abilities to engage in competitions even though they may live in different locations and may never actually see each other.

In another embodiment, information regarding an athlete's weight is stored in the database. In this embodiment, a scale having a weight transmitting device is used by the athlete in a health club or at a weight loss facility. The weight data is transmitted to the smart card 12 for some embodiments and to the database for other embodiments. The weight data is accessible by the athlete and for some embodiments, personnel of the weight loss company. For other embodiments, the weight data is accessible by the athlete's trainer and designated health club personnel.

For one other embodiment, illustrated in FIG. 6, restaurants provide data for entry into the database 13 relating to the food on their menus. For instance, restaurants enter information such as calories, protein, fiber, and fat in entrees, salads, desserts and so forth. The restaurant's identity and restaurant's location is also entered. Athletes, trainers, and health club personnel may access this data prior to going to the restaurant. In one embodiment, an athlete obtains a list of restaurants providing data and views food on the menu. The athlete identifies suitable food based upon directions inputted by the athlete's trainer or health club.

In another embodiment, the dietary information provided by the restaurants is downloaded to the athlete's smart card. Also downloaded are criteria for food that the athlete may consume entered by the trainer or the health club. The criteria may block the athlete from ordering particular items because of their caloric content. For this embodiment, when the athlete enters the restaurant, he or she provides the smart card to restaurant personnel. The personnel inserts the card into a card reader and prints out a menu of allowed food. While printing out is described, any other medium for displaying or communicating allowed foods is suitable for use in the invention.

In one other embodiment, the restaurant uploads information about the food the athlete consumed to the athlete's smart card. The data is uploaded to the database 13 and posted on the athlete's webpage when the athlete swipes his or her card at the health club.

The invention thus conceived can be subject to numerous modifications and variations, without thereby departing from the scope of the inventive concept. Moreover, all components can be replaced by technically equivalent elements.

1. A system for optimizing performance and for maintaining wellness of an athlete, comprising:
a smart card for receiving, storing, and transmitting data regarding one or more of heart rate, weight, age, and gender of an athlete and instructions from the athlete's trainer or the athlete's health club or both regarding exercise;
a processor for processing data obtained from the smart card;
a database with electronic fitness records for the a plurality of athletes, the database comprising data obtained from the smart card; and,
access enabling the athlete's trainer, the athlete's health club or both to access the fitness records of all of the athletes that the trainer trains.

2. The system of claim 1, further comprising access enabling the athlete the access his or her electronic records.

3. The system of claim 1, wherein the trainer or health club or both are able to access electronic fitness records over the Internet.

4. The system of claim 2 wherein the athlete accesses his or her electronic fitness record over the Internet.

5. The system of claim 1, further comprising fitness equipment with one or more smart card readers capable of reading data on the smart card.

6. The system of claim 5 wherein the fitness equipment generates settings regarding speed and time based upon instructions obtained from the smart card.

7. The system of claim 5 wherein the fitness equipment is capable of reading trainers' instructions for the athlete.

8. The system of claim 5 wherein the fitness equipment is capable of transmitting electronic fitness records for storage to the database fitness records accessible by the trainer.

9. The system of claim 5 wherein the electronic fitness records are stored within a memory on the smart card.

10. The system of claim 9, wherein the electronic fitness records include heart rate information, calories burned, lactic acid concentrations, and duration of the exercise.

11. A system for optimizing performance and for maintaining wellness of an athlete, comprising:
an RFID device for receiving, storing, and transmitting data regarding one or more of heart rate, weight, age, and gender of an athlete and instructions from the athlete's trainer or the athlete's health club or both regarding exercise;
a processor for processing data obtained from the RFID device;
a database with electronic fitness records for the a plurality of athletes, the database comprising data obtained from the RFID device; and,
access enabling the athlete's trainer health club or both to access the fitness records of all of the athletes that the trainer trains.

12. A system for optimizing performance and for maintaining wellness of an athlete, comprising:
a Personal Digital Assistant for receiving, storing, and transmitting data regarding one or more of heart rate, weight, age, and gender of an athlete and instructions from the athlete's trainer or the athlete's health club or both regarding exercise;
a processor for processing data obtained from the Personal Digital Assistant;
a database with electronic fitness records for the a plurality of athletes, the database comprising data obtained from the Personal Digital Assistant; and,
access enabling the athlete's trainer health club or both to access the fitness records of all of the athletes that the trainer trains.

13. A method for increasing a fitness trainer's capacity to train athletes, comprising:
providing the system of claim 1 for the trainer and athletes; and
using the system to increase the number of athletes trained.

14. A method for increasing a fitness trainer's capacity to train athletes, comprising:
providing the system of claim 11 for the trainer and athletes; and
using the system to increase the number of athletes trained.

15. A method for increasing a fitness trainer's capacity to train athletes, comprising:
providing the system of claim 12 for the trainer and athletes; and
using the system to increase the number of athletes trained.

16. A method for enabling a trainer to track athletes' performances in races, comprising:
obtaining race data from the athlete or from a race database;
adding the data to a second database; and
presenting the data so that the trainer views race results for each athlete the trainer trains.

17. The method of claim 12 wherein the data is presented so that other athletes view the data.

18. The method of claim 13 wherein the data from more than one athlete is presented so that other athletes view the data.

19. The method of claim 12 wherein the data is stored in the database of the system of claim 1.

20. The method of claim 14, further comprising providing an incentive for the athlete with the best race performance.

21. Computer readable media for presenting the data of claim 14.

22. Computer readable media for identifying the athlete with the best race performance.

23. A smart card comprising a reader for reading heart rate data.

24. The smart card of claim 19 further comprising a memory for storing heart rate data.

25. An RFID card comprising a reader for reading heart rate data.

26. The RFID card comprising a reader for reading heart rate data.
